(19) United States
(12) Patent Application Publication
(10) Pub. No.: US 2025/0160371 A1
(43) Pub. Date: May 22, 2025

(54) BEVERAGE COMPOSITIONS FOR HYDRATION AND FOR SUPPORT OF HAIR HEALTH

(71) Applicant: CELMATRIX CORPORATION, Henderson, NV (US)

(72) Inventor: SHAHIN SHANE MALEK, Henderson, NV (US)

(21) Appl. No.: 18/755,697

(22) Filed: Jun. 27, 2024

Related U.S. Application Data
(63) Continuation-in-part of application No. 18/513,527, filed on Nov. 18, 2023.

(51) Int. Cl. A23L 2/66; A23L 2/56; A23L 2/68

(52) U.S. Cl. CPC A23L 2/66; A23L 2/56; A23L 2/68

(57) ABSTRACT

Beverage compositions for hydration and supporting head hair health are described. The beverage compositions may be formulated with (i) aqueous beverage medium, e.g., water, or water and tea, or water and caffeine, and (ii) hair benefit ingredients, such as: trace elements and/or oxides and/or salts and/or derivatives thereof; vitamins and derivatives thereof; proteins; amino acids; and plant extracts.

### CROSS-REFERENCE TO RELATED APPLICATION

This is a continuation-in-part under 35 USC § 120 of U.S. patent application Ser. No. 18/513,527 filed Nov. 18, 2023 in the name of Shahin Shane Malek for BEVERAGE COMPOSITIONS FOR HYDRATION AND FOR SUPPORT OF HAIR HEALTH. The disclosure of U.S. patent application Ser. No. 18/513,527 is hereby incorporated herein by reference, in its entirety, for all purposes.

### FIELD

The present disclosure relates to beverage compositions for oral consumption for hydration and for support of head hair health, including for example the promotion of hair growth and healthy appearance of head hair.

### DESCRIPTION OF THE RELATED ART

A large number of topically applied hair growth compositions are known in the art, utilizing a variety of active ingredients for promoting hair growth of persons who suffer from hair loss. There also exist many different types of shampoos, conditioners, and hair rinses that are formulated for topical application to the hair to support hair health and beauty.

Various disadvantages of topically applied hair benefit compositions include adverse dermatological and systemic side effects, lengthy times and inconvenient application requirements for topical contacting with the hair benefit composition to achieve the desired enhancement effect, and the presence in many products of ingredients that are not environmentally benign.

### SUMMARY

The present disclosure relates broadly to beverage compositions for human oral consumption for hydration and support of head hair health, including for example the promotion of head hair growth and healthy appearance of head hair.

In various aspects, the disclosure relates to a beverage composition for oral consumption for hydration and support of head hair health, comprising one or more head hair benefit ingredient(s), in an aqueous beverage medium. The aqueous beverage medium in various embodiments may comprise water, or water and tea, or water and caffeine.

In one aspect, the disclosure relates to a beverage composition for oral consumption for support of head hair health, comprising an aqueous beverage medium comprising carbonated or non-carbonated water, biotin, zinc, thiamine, reishi mushroom extract, lion's mane mushroom extract, ashwagandha root extract, foti root extract, plant sterols, horsetail extract, Pygeum africanum, protein, and BCAA 2:1:1.

In another aspect, the disclosure relates to a tea beverage composition for oral consumption for support of head hair health comprises an aqueous beverage medium comprising water, tea, biotin, zinc, thiamine, reishi mushroom extract, lion's mane mushroom extract, ashwagandha root extract, foti root extract, plant sterols, horsetail extract, Pygeum africanum, protein, and BCAA 2:1:1.

In yet another aspect, the disclosure relates to an energizing beverage composition for oral consumption for support of head hair health, comprising an aqueous beverage medium comprising water, caffeine, biotin, zinc, thiamine, reishi mushroom extract, lion's mane mushroom extract, ashwagandha root extract, foti root extract, bamboo extract, plant sterols, horsetail extract, Pygeum africanum, Vitamin B3, Vitamin B12, L-theanine, taurine, selenium, and BCAA 2:1:1.

In a further aspect, the disclosure relates to a beverage composition for hydration and for support of head hair health, comprising amla; zinc; selenium; vitamins A-E; and water.

Another aspect of the disclosure relates to a packaged beverage composition for hydration and for support of head hair health, comprising packaging containing a beverage composition of the present disclosure.

Yet another aspect of the disclosure relates to a method of concurrently mediating hydration and head hair health of a human subject in need thereof, the method comprising administering to the human subject a beverage composition of the present disclosure.

Other aspects, features and embodiments of the disclosure will be more fully apparent from the ensuing description and appended claims.

### DETAILED DESCRIPTION

The present disclosure generally relates to beverage compositions for oral consumption for hydration and for support of hair health.

As used herein and in the appended claims, the singular forms “a”, “an”, and “the” include plural referents unless the context clearly dictates otherwise.

In various aspects, the disclosure relates to a beverage composition for oral consumption for support of head hair health, comprising (i) an aqueous beverage medium, and (ii) one or more head hair health benefit ingredient(s). The aqueous beverage medium in various embodiments may comprise water, which may be carbonated or non-carbonated, and in other embodiments the aqueous beverage medium may comprise water and tea, and in still other embodiments the aqueous beverage medium may comprise water and caffeine.

Such beverage composition may contain head hair health benefit ingredient(s) such as any one or more of the following:
(i) trace element(s) such as zinc, calcium, selenium (e.g., selenomethionine), manganese, potassium, sodium, and iron, among others, and/or oxides and/or salts and/or derivatives (e.g., citrate, chloride, sodium, and sulfate salts, and benzoates and gluconates) thereof, such as magnesium citrate, potassium sorbate, potassium iodine (potassium iodide), sodium benzoate, sodium gluconate, zinc citrate and sodium chloride (e.g., sea salt);
(ii) vitamin(s) such as: vitamin A; vitamin B, e.g., riboflavin (vitamin B1), biotin (vitamin B7), folate (vitamin B9), thiamine (vitamin B1), niacin and/or niacinamide (vitamin B3), pantothenic acid (vitamin B5), pyridoxine (vitamin B6), and cobalamins (vitamin B12), etc.; vitamin C (ascorbic acid); vitamin D; vitamin E; and vitamin K; and derivatives thereof, such as thiamine HCl;
(iii) protein(s), such as soy protein, egg white protein, whey protein, casein protein, pea protein, rice protein, hemp protein, collagen, shark cartilage, branched chain proteins, and other plant and animal proteins, such as branched chain proteins;
(iv) amino acid(s), such as alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, and valine, and branched chain amino acids (BCAA) and BCAA blends, e.g., a BCAA blend of leucine, isoleucine, and valine, such as a blend of L-leucine:L-isoleucine, and L-valine, in a weight ratio of 2:1:1 of L-leucine:L-isoleucine:L-valine (BCAA 2:1:1), amino sulfonic acids (e.g., taurine), and amino acid analogs (e.g., L-theanine); and
(v) plant extract(s) such as any of amla extract, ashwagandha root extract, bamboo extract, reishi mushroom extract, lion's mane mushroom extract, foti root (Polygonum multiflorum) extract, holy basil (Ocimum tenuiflorum) extract, horsetail (Equisetum arvense) extract, turmeric root, Pygeum africanum, mountain ash (Sorbus aucupario L. Rosaceae) berries extract, saw palmetto (Serenoa repens) fruit extract, raspberry juice concentrate, plant sterols and/or stannols (which may be or comprise sterols and stanols present in the plant extracts of the beverage composition, such as foti root extract, horsetail extract, etc., or alternatively may be separately and additionally added to the beverage composition, e.g., beta-sitosterol, stanol ester, campesterol, avenasterol, isofucosterol, sterolin, brassicasterol, sterol ester, stigmasterol, etc.), natural flavors (cocoa, vanilla, strawberry, lemon, lime, kiwi, banana), stevia extract, soy, vegetable glycerine, and citric acid, and the beverage composition may include any other hair benefit ingredient(s) that are physiologically acceptable for human oral consumption and that in the composition function to support head hair health, e.g., to promote head hair growth and healthy head hair characteristics.

It will be recognized that hair benefit ingredients employed in the beverage compositions of the present disclosure may be in derivatized forms. For example, zinc when present may be in elemental form, or may be in an oxide compound, or may be in a salt compound (as zinc chloride, or other form), or may be in other compound, chelate, or complex containing zinc. Likewise, any of the proteins, amino acids, and/or plant extracts may be in derivatized forms in the beverage composition. For example, thiamine (thiamin) may be in present in the beverage composition as thiamine per se, or in a derivatized form such as thiamine hydrochloride (thiamine HCl).

The beverage compositions of the present disclosure may be formulated to contain a substantial protein content, including proteins as well as amino acids, which may for example the present in a total protein/amino acid content of up to 25 grams in a packaged beverage composition of 6-16 fluid ounces, e.g., in a range of from 1 to 25 grams of total protein/amino acid components, or in a range of from 5 to 20 grams of total protein/amino acid components, or in other suitable range for such fluid volume of the beverage composition.

In various embodiments, the disclosure relates to a beverage composition for oral consumption for support of head hair health, comprising an aqueous beverage medium comprising carbonated or non-carbonated water, biotin, zinc, thiamine, reishi mushroom extract, lion's mane mushroom extract, ashwagandha root extract, foti root extract, plant sterols, horsetail extract, Pygeum africanum, protein, and BCAA 2:1:1.

Such beverage composition may optionally further comprise any one or more of the following ingredients: citric acid, natural flavor(s), magnesium citrate, potassium sorbate, sodium benzoate, sodium gluconate, sea salt, stevia leaf extract, ascorbic acid, zinc citrate, niacinamide, saw palmetto fruit extract, potassium iodine, selenomethionine, and thiamine HCl.

In another aspect, the disclosure relates to a tea beverage composition for oral consumption for support of head hair health, comprising (i) an aqueous beverage medium comprising water and tea, and (ii) one or more head hair health benefit ingredient(s).

In various embodiments, the tea beverage composition for oral consumption for support of head hair health comprises an aqueous beverage medium comprising water, tea, biotin, zinc, thiamine, reishi mushroom extract, lion's mane mushroom extract, ashwagandha root extract, foti root extract, plant sterols, horsetail extract, Pygeum africanum, protein, and BCAA 2:1:1.

Such tea beverage composition may optionally further comprise any one or more of the following ingredients: citric acid, natural flavor(s), magnesium citrate, potassium sorbate, sodium benzoate, sodium gluconate, sea salt, stevia leaf extract, ascorbic acid, zinc citrate, niacinamide, saw palmetto fruit extract, potassium iodine, selenomethionine, and thiamine HCl.

In a further aspect, the disclosure relates to an energizing beverage composition for oral consumption for support of head hair health, comprising (i) an aqueous beverage medium comprising water and caffeine, and (ii) one or more head hair health benefit ingredient(s).

In various embodiments, the energizing beverage composition for oral consumption for support of head hair health comprises an aqueous beverage medium comprising water, caffeine, biotin, zinc, thiamine, reishi mushroom extract, lion's mane mushroom extract, ashwagandha root extract, foti root extract, bamboo extract, plant sterols, horsetail extract, Pygeum africanum, Vitamin B3, Vitamin B12, L-theanine, taurine, selenium, and BCAA 2:1:1.

Such energizing beverage composition may optionally further comprise any one or more of the following ingredients: citric acid, natural flavors, magnesium citrate, potassium sorbate, sodium benzoate, sodium gluconate, sea salt, stevia leaf extract, ascorbic acid, green tea extract (caffeine), zinc citrate, saw palmetto fruit extract, potassium iodine, selenomethionine, thiamin HCl.

The foregoing beverage compositions may be formulated with any suitable concentrations and amounts of the variously identified ingredients thereof, and with any other hair benefit ingredient(s) that are physiologically acceptable for human oral consumption and that in the composition function to support head hair health, e.g., to promote head hair growth and healthy head hair characteristics.

In all compositions of the present disclosure, all ingredients are present in respective physiologically acceptable amounts for human consumption.

As an illustrative specific embodiment, a beverage composition may comprise the composition set out below having the following weight percentages of the respective ingredients, wherein the respective weight percentages are based on the total weight of the composition, and the total weight percentages of all ingredients in the composition is 100 weight percent:

### Ingredient Weight Percent

chromium 0.00022%
iodine 0.00055%
selenium 0.00022%
zinc 0.00660%
vitamin A 0.00055%
vitamin B 0.00726%
vitamin C 0.02200%
vitamin D 0.00002%
vitamin E 0.00220%
blend* 1.96038%
water 98.0000. %
TOTAL 100 weight percent
* blend of plant extracts of ashwagandha root extract, reishi mushroom extract, lion's mane mushroom extract, holy basil extract, turmeric root, raspberry juice concentrate, natural flavors, stevia extract, vegetable glycerine, potassium sorbate, and citric acid

In another aspect, the disclosure relates to a beverage composition for oral consumption for hydration and for support of head hair health, such beverage composition comprising (i) amla and (ii) one or more head hair benefit ingredient(s), in a suitable beverage medium.

As used herein, “amla” is an extract from the fruit of the Emblica officinalis plant, containing polyphenols, e.g., ellagic acid, chebulinic acid, gallic acid, chebulagic acid, apeigenin, quercetin, corilagin, and leutolin, as well as hydrolysable tannins. Amla may be employed in the beverage compositions of the present disclosure in any suitable concentrations or amounts, and may be formulated into such beverage compositions in any appropriate ingredient form, such as for example in the form of a paste, oil, juice, or powder derived from such plant from the fruit of the Emblica officinalis plant.

In such beverage compositions, amla and other ingredients of the beverage composition are advantageously solubilized in a suitable beverage medium, which may for example be or comprise water or other aqueous beverage medium, and in various embodiments may be or comprise any of coffees, teas, milks, juices, colas, and the like.

In various embodiments, amla is present in the beverage compositions in an amount of from 0.1 wt % to 5% wt %, based on the total weight of the composition, and in specific formulations of the beverage compositions may be present in an amount of from 0.25 wt % to 5 wt %, or from 0.5 to 4 wt %, or from 0.5 wt % to 2.5 wt %, on the same total weight basis of the composition, although the disclosure is not limited thereto, and other beverage composition amounts of amla may be usefully employed in the practice of the present disclosure.

In various embodiments, amla is formulated with one or more physiologically acceptable head hair benefit ingredient(s), i.e., ingredients that support and promote hair health. The hair benefit ingredient(s) may for example include any one or more of: trace elements such as zinc, calcium, and selenium, among others, and/or oxides and/or salts (e.g., citrate, chloride, sodium, and sulfate salts) thereof; vitamins such as: vitamin A; vitamin B, e.g., riboflavin, biotin, folate, thiamine, niacin, pantothenic acid, pyridoxine, and cobalamins, etc.; vitamin C; vitamin D; vitamin E; and vitamin K; plant extracts such as any one or more of ashwagandha, reishi mushroom, lion's mane mushroom, holy basil, turmeric root, raspberry juice concentrate, natural flavors, stevia extract, vegetable glycerine, potassium sorbet, and citric acid; and may include any other hair benefit ingredient(s) that are physiologically acceptable for human consumption and that in the composition function to support head hair health, e.g., to promote head hair growth and healthy head hair characteristics. Trace metal elements such as zinc and selenium have been found to be particularly advantageous in various embodiments of such beverage compositions.

Beverage compositions for hydration and for support of head hair health, may thus be formulated as comprising (i) amla and (ii) one or more head hair benefit ingredient(s), e.g., one or more head hair benefit ingredient(s) comprising one or more selected from the group consisting of: head hair benefit trace metal elements and oxides and salts thereof; and head hair benefit vitamins, with such ingredients (i) and (ii) being solubilized in a suitable physiologically acceptable beverage medium, such as water or other aqueous beverage medium, or other beverage medium.

The ingredients (i) and (ii) of the amla beverage composition may be provided or processed in a form in which when blended with water form a clear liquid beverage solution.

Such beverage compositions may be formulated by blending soluble ingredients including ingredients (i) and (ii) into water or other beverage medium.

The beverage compositions in other embodiments may comprise amla and one or more plant extracts such as ashwagandha, reishi mushroom, lion's mane mushroom, holy basil, turmeric root, raspberry juice concentrate, natural flavors, stevia extract, vegetable glycerine, potassium sorbet, and citric acid, in a beverage medium such as water or other aqueous beverage medium, or other beverage medium. Such beverage compositions may additionally comprise one or more selected from the group consisting of: head hair benefit trace metal elements and oxides and salts thereof; and head hair benefit vitamins, e.g., any one or more of vitamins A-E.

Such beverage compositions may further comprise chromium and iodine.

The amla-containing beverage compositions in addition to supporting head hair health and promoting growth of head hair have also been found to be beneficial to support health of skin and nails.

In various preferred embodiments of the amla-containing beverage composition, the beverage composition comprises amla, zinc, selenium, and one or more vitamins. In such compositions, the selenium may be in an amount of from 10 to 150 μg, but the disclosure is not limited thereto, and other selenium amounts or concentrations may be employed within the broad practice of the present disclosure. Zinc may be present in such compositions in an amount of from 5 to 40 mg, but the disclosure is not limited thereto, and other selenium amounts or concentrations may be employed. The vitamins in the composition may be of any suitable type, and may for example comprise one or more of vitamins A, B, C, D, and E. In various embodiments, the vitamins in the amla-containing composition include riboflavin and biotin.

As an illustrative specific embodiment, the amla-containing beverage composition may comprise amla, selenium, zinc, and vitamins A-E in aqueous beverage medium.

More generally, the beverage compositions of the present disclosure may be provided in a suitable packaged form, comprising packaging containing the beverage composition, such as for example containing a single serving amount of the beverage composition, e.g., as a bottled or canned volume of 6 to 12 fluid ounces, or more, or as a multiple servings amount of the beverage composition, e.g., as a bottled or canned volume of 16 to 32 fluid ounces, or in other suitable volumes and packaged forms.

The present disclosure in a method aspect relates to a method of concurrently mediating hydration and head hair health of a human subject in need thereof, such method comprising administering to the human subject an aqueous beverage composition of the present disclosure. The present disclosure in such respect provides a drink composition that is efficacious for hydration of a consumer thereof, while simultaneously providing head hair health benefit to such consumer.

Beverage compositions of the present disclosure have been found to mediate enhanced growth of head hair in human subjects consuming such beverage compositions for sustained periods of 4-6 weeks, as compared to human subjects not consuming the beverage compositions but otherwise having substantially similar dietary, sleep, and exercise activity.

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

What is claimed is:

1. A beverage composition for oral consumption for hydration and support of head hair health, comprising an aqueous beverage medium comprising carbonated or non-carbonated water, biotin, zinc, thiamine, reishi mushroom extract, lion's mane mushroom extract, ashwagandha root extract, foti root extract, plant sterols, horsetail extract, Pygeum africanum, protein, and BCAA 2:1:1.

2. The beverage composition of claim 1, further comprising any one or more of the following ingredients: citric acid, natural flavor(s), magnesium citrate, potassium sorbate, sodium benzoate, sodium gluconate, sea salt, stevia leaf extract, ascorbic acid, zinc citrate, niacinamide, saw palmetto fruit extract, potassium iodine, selenomethionine, and thiamine HCl.

3. A packaged beverage composition for hydration and support of head hair health, comprising packaging containing the beverage composition of claim 1.

4. A method of concurrently mediating hydration and head hair health of a human subject in need thereof, the method comprising administering to the human subject the beverage composition of claim 1.

5. A tea beverage composition for oral consumption for hydration and support of head hair health, comprising an aqueous beverage medium comprising water and tea, biotin, zinc, thiamine, reishi mushroom extract, lion's mane mushroom extract, ashwagandha root extract, foti root extract, plant sterols, horsetail extract, Pygeum africanum, protein, and BCAA 2:1:1.

6. The tea beverage composition of claim 5, further comprising any one or more of the following ingredients: citric acid, natural flavor(s), magnesium citrate, potassium sorbate, sodium benzoate, sodium gluconate, sea salt, stevia leaf extract, ascorbic acid, zinc citrate, niacinamide, saw palmetto fruit extract, potassium iodine, selenomethionine, and thiamine HCl.

7. A packaged tea beverage composition for hydration and support of head hair health, comprising packaging containing the tea beverage composition of claim 5.

8. A method of concurrently mediating hydration and head hair health of a human subject in need thereof, the method comprising administering to the human subject the tea beverage composition of claim 5.

9. An energizing beverage composition for oral consumption for support of head hair health comprises an aqueous beverage medium comprising water, caffeine, biotin, zinc, thiamine, reishi mushroom extract, lion's mane mushroom extract, ashwagandha root extract, foti root extract, bamboo extract, plant sterols, horsetail extract, Pygeum africanum, Vitamin B3, Vitamin B12, L-theanine, taurine, selenium, and BCAA 2:1:1.

10. The energizing beverage composition of claim 9, further comprising any one or more of the following ingredients: citric acid, natural flavors, magnesium citrate, potassium sorbate, sodium benzoate, sodium gluconate, sea salt, stevia leaf extract, ascorbic acid, green tea extract (caffeine), zinc citrate, saw palmetto fruit extract, potassium iodine, selenomethionine, thiamin HCl.

11. A packaged energizing beverage composition for hydration and support of head hair health, comprising packaging containing the energizing beverage composition of claim 9.

12. A method of concurrently mediating hydration and head hair health of a human subject in need thereof, the method comprising administering to the human subject the energizing beverage composition of claim 9.
